(19) United States
(12) Patent Application Publication
(10) Pub. No.: US 2006/0088222 A1
(43) Pub. Date: Apr. 27, 2006

(54) Video coding method and apparatus

(75) Inventors: Woo-jin Han, Suwon-si (KR); Bae-keun Lee, Bucheon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/247,147

(22) Filed: Oct. 12, 2005

Related U.S. Application Data
(60) Provisional application No. 60/620,330, filed on Oct. 21, 2004.

(30) Foreign Application Priority Data
Nov. 13, 2004 (KR) 10-2004-0092821

(51) Int. Cl. G06K 9/36

(52) U.S. Cl. 382/232

(57) ABSTRACT

A video coding method and apparatus are provided for improving compression efficiency or video/image quality by selecting a spatial transform method suitable for characteristics of an incoming video/image during video/image compression. The video coding apparatus includes a temporal transform module for removing temporal redundancy in an input frame to generate a residual frame, a wavelet transform module for performing wavelet transform on the residual frame to generate a wavelet coefficient, a Discrete Cosine Transform (DCT) module for performing DCT on the wavelet coefficient of each DCT block to create a DCT coefficient, and a quantization module for quantizing the DCT coefficient.

### CROSS-REFERENCE TO RELATED APPLICATIONS

This application claims priority from Korean Patent Application No. 10-2004-0092821 filed on Nov. 13, 2004 in the Korean Intellectual Property Office, and U.S. Provisional Patent Application No. 60/620,330 filed on Oct. 21, 2004 in the United States Patent and Trademark Office, the disclosures of which are incorporated herein by reference in their entirety.

### BACKGROUND OF THE INVENTION

1. Field of the Invention

Apparatuses and methods consistent with the present invention relate to video/image compression, and more particularly, to video coding that can improve compression efficiency or image quality by selecting a spatial transform method suitable for characteristics of an incoming video/image.

2. Description of the Related Art

With the development of communication technology such as the Internet, video communication as well as text and voice communication has dramatically increased. Conventional text communication cannot satisfy the various demands of users, and thus, multimedia services that can provide various types of information such as text, pictures, music, and video have increased. Multimedia data requires a large storage capacity and a wide bandwidth for transmission since the amount of multimedia data is usually large relative to other types of data. Accordingly, a compression coding method is requisite for transmitting multimedia data including text, moving pictures (hereafter referred to as “video”), and audio.

In such multimedia data compression techniques, compression can largely be classified into lossy/lossless compression, according to whether source data is lost, intraframe/interframe compression, according to whether individual frames are compressed independently, and symmetric/asymmetric compression, according to whether time required for compression is the same as time required for recovery. In addition, data compression is defined as real-time compression when the compression/recovery time delay does not exceed 50 ms, and as scalable compression when frames have different resolutions. As examples, for text or medical data, lossless compression is usually used. For multimedia data, lossy compression is usually used.

A basic principle of data compression is the removal of data redundancy. Data redundancy is typically defined as: spatial redundancy where the same color or object is repeated in an image, temporal redundancy where there is little change between adjacent frames in a moving image or the same sound is repeated in audio, or mental/visual redundancy, which takes into account peoples' inability to perceive high frequencies.

Among various data compression techniques, discrete cosine transform (DCT) and wavelet transform are the most common data compression techniques in current use.

The DCT is widely used for image processing methods such as the JPEG, MPEG, and H.264 standards. These standards use DCT block division, which involves dividing an image into DCT blocks each having a predetermined pixel size, e.g., 4×4, 8×8, and 16×16, and performing the DCT on each block independently, followed by quantization and encoding. When the size of DCT blocks increases, the degree of complexity of the algorithm becomes very high while considerably reducing block effects of a decoded image.

Wavelet coding is a widely used image coding technique, but its algorithm is rather complex compared to the DCT algorithm. In view of compression requirements, the wavelet transform is not as effective as the DCT. However, the wavelet transform produces a scalable image with respect to resolution, and takes into account information on pixels adjacent to a pertinent pixel in addition to the pertinent pixel during the wavelet transform. Therefore, the wavelet transform is more effective than the DCT for an image having high spatial correlation, that is, a smooth image.

Both the DCT and the wavelet transform are lossless compression techniques, and original data can be perfectly reconstructed through an inverse transform operation. However, actual data compression may be performed by discarding less important information in cooperation with a quantizing operation.

The DCT technique is known to have the best image compression efficiency. According to the DCT technique, however, an image is accurately divided into DCT blocks and DCT coding is performed on each block. Thus, although pixels positioned adjacent to a DCT block boundary are spatially correlated with pixels of other DCT blocks, the spatial correlation cannot be properly exploited. On the contrary, the wavelet transform is advantageous in that it can take advantage of the spatial correlation between pixels because the information on adjacent pixels can be taken into consideration during the transform.

In view of characteristics of the two transform techniques, the wavelet transform is suitable for a smooth image having high spatial correlation while the DCT is suitable for an image having low spatial correlation and many block artifacts.

Therefore, there is a still need to develop a spatial transform technique that is able to exploit the advantages of the DCT and the wavelet transform.

### SUMMARY OF THE INVENTION

The present invention provides a method and apparatus for performing DCT after performing wavelet transform for spatial transform during a video compression.

The present invention also provides a method and apparatus for performing video compression by selectively performing both DCT and wavelet transform or performing only DCT. Furthermore, the present invention presents criteria for selecting a spatial transform method suitable for characteristics of an incoming video/image.

The present invention also provides a method and apparatus for supporting Signal-to-Noise Ratio (SNR) scalability by applying Fine Granular Scalability (FGS) to the result obtained after performing wavelet transform and DCT.

According to an aspect of the present invention, there is provided a video encoder including a temporal transform module removing temporal redundancy in an input frame to generate a residual frame, a wavelet transform module performing wavelet transform on the residual frame to generate a wavelet coefficient, a DCT module performing DCT on the wavelet coefficient for each DCT block to create a DCT coefficient, and a quantization module applying quantization to the DCT coefficient. A horizontal length and a vertical length of the lowest subband image in the wavelet transform are an integer multiple of the size of the DCT block.

According to another aspect of the present invention, there is provided an image encoder including a wavelet transform module performing wavelet transform on an input image to create a wavelet coefficient, a DCT module performing DCT on the wavelet coefficient for each DCT block to create a DCT coefficient, and a quantization module applying quantization to the DCT coefficient.

According to still another aspect of the present invention, there is provided a video encoder including a temporal transform module removing temporal redundancy in an input frame to generate a residual frame, a wavelet transform module performing wavelet transform on the residual frame to generate a wavelet coefficient, a DCT module performing DCT on the wavelet coefficient for each DCT block to create a DCT coefficient, a quantization module applying quantization to the DCT coefficient according to a predetermined criterion and creating a quantization coefficient for a base layer, and a Fine Granular Scalability (FGS) module decomposing a difference between the quantization coefficient for the base layer and the DCT coefficient into a plurality of bit planes.

According to a further aspect of the present invention, there is provided a video encoder including a temporal transform module removing temporal redundancy in an input frame to generate a residual frame, a mode selection module selecting one of a first mode in which only DCT is performed during spatial transform and a second mode in which wavelet transform is followed by DCT for spatial transform according to the spatial correlation of the residual frame, a wavelet transform module performing wavelet transform on the residual frame to generate a wavelet coefficient when the second mode is selected, a DCT module performing DCT on the wavelet coefficient when the second mode is selected and on the residual frame for each DCT block when the first mode is selected to thereby create a DCT coefficient, and a quantization module applying quantization to the DCT coefficient.

According to still a further aspect of the present invention, there is provided a video encoder including a temporal transform module removing temporal redundancy in an input frame to generate a residual frame, a mode selection module selecting one of a first mode in which only DCT is performed during spatial transform and a second mode in which wavelet transform is followed by DCT for spatial transform according to the spatial correlation of the residual frame, a wavelet transform module performing wavelet transform on the residual frame to generate a wavelet coefficient when the second mode is selected, a DCT module performing DCT on the wavelet coefficient when the second mode is selected and on the residual frame for each DCT block when the first mode is selected to thereby create a DCT coefficient, a quantization module applying quantization to the DCT coefficient according to a predetermined criterion and creating a quantization coefficient for a base layer, and an FGS module decomposing a difference between the quantization coefficient for the base layer and the DCT coefficient into a plurality of bit planes.

According to yet another aspect of the present invention, there is provided a video encoder including a temporal transform module removing temporal redundancy in an input frame to generate a residual frame, a wavelet transform module performing wavelet transform on the residual frame to generate a wavelet coefficient, a DCT module performing DCT on the residual frame for each DCT block to generate a first DCT coefficient while performing DCT on the wavelet coefficient for each DCT block to generate a second DCT coefficient, a quantization module applying quantization to the first and second DCT coefficients to generate first and second quantization coefficients, respectively, and a mode selection module reconstructing first and second residual frames from the first and second quantization coefficients, comparing the quality of the first residual frame with that of the second residual frame, and selecting a mode that offers a better quality residual frame.

According to still yet another aspect of the present invention, there is provided a video encoder including a temporal transform module removing temporal redundancy in an input frame to generate a residual frame, a wavelet transform module performing wavelet transform on the residual frame to generate a wavelet coefficient, a DCT module performing DCT on the residual frame for each DCT block to generate a first DCT coefficient while performing DCT on the wavelet coefficient for each DCT block to generate a second DCT coefficient, a quantization module applying quantization to the first and second DCT coefficients to generate first and second quantization coefficients for a base layer, respectively, according to a predetermined criterion, a mode selection module reconstructing first and second residual frames from the first and second quantization coefficients, comparing the quality of the first residual frame with that of the second residual frame, and selecting a mode that offers a better quality residual frame, and an FGS module decomposing a difference between either the first or the second quantization coefficient corresponding to the selected mode and either the first or the second DCT coefficient corresponding to the selected mode into bit planes.

According to another aspect of the present invention, there is provided an image decoder including an inverse quantization module inversely quantizing texture information contained in an input bitstream, an inverse DCT module performing inverse DCT on the inversely quantized value for each DCT block, and an inverse wavelet transform module performing inverse wavelet transform on the inversely DCT transformed value.

According to still another aspect of the present invention, there is provided a video decoder including an inverse quantization module inversely quantizing texture information contained in an input bitstream, an inverse DCT module performing inverse DCT on the inversely quantized value for each DCT block, an inverse wavelet transform module performing inverse wavelet transform on the inversely DCT transformed value, and an inverse temporal transform module reconstructing a video sequence using the inversely wavelet transformed value and motion information in the bitstream.

According to yet another aspect of the present invention, there is provided a video decoder including an inverse quantization module inversely quantizing texture information contained in an input bitstream, an inverse DCT module performing inverse DCT on the inversely quantized value for each DCT block and sending the inversely DCT transformed value to an inverse temporal transform module when mode information contained in the bitstream represents a first mode and to an inverse wavelet transform module when the mode information represents a second mode, an inverse wavelet transform module performing inverse wavelet transform on the inversely DCT transformed value, and an inverse temporal transform module reconstructing a video sequence using the inversely DCT transformed value and the motion information in the bitstream when the mode information represents the first mode while reconstructing a video sequence using the inversely wavelet transformed value and the motion information when the mode information represents the second mode.

### BRIEF DESCRIPTION OF THE DRAWINGS

The above and other aspects of the present invention will become more apparent by describing in detail exemplary embodiments thereof with reference to the attached drawings in which:

FIG. 1 shows the configuration of a video encoder according to a first exemplary embodiment of the present invention;

FIG. 2 illustrates a process of decomposing an input image or frame into subbands at two levels by wavelet transform;

FIG. 3 is a detailed diagram illustrating the decomposing process shown in FIG. 2;

FIG. 4 is a diagram for explaining a process of performing DCT on a wavelet-transformed frame;

FIG. 5 shows the configuration of an image encoder for encoding an incoming still image;

FIG. 6 shows the configuration of a video encoder supporting FGS after performing wavelet transform and DCT according to a second exemplary embodiment of the present invention;

FIG. 7 shows the detailed configuration of the FGS module shown in FIG. 6;

FIG. 8 shows an example of difference coefficients of a DCT block;

FIG. 9 is a block diagram of a video encoder according to a third exemplary embodiment of the present invention;

FIG. 10 is a block diagram of a video encoder according to a fourth exemplary embodiment of the present invention;

FIG. 11 shows an example of the mode selection module shown in FIG. 10;

FIG. 12 is a block diagram of a video encoder according to a fifth exemplary embodiment of the present invention;

FIG. 13 is a block diagram of a video decoder according to the present invention; and

FIG. 14 is a block diagram of a system for performing an encoding or decoding process according to the present invention.

### DETAILED DESCRIPTION OF EXEMPLARY EMBODIMENTS OF THE INVENTION

The present invention will now be described more fully with reference to the accompanying drawings, in which exemplary embodiments of the invention are shown. Advantages and features of the present invention and methods of accomplishing the same may be understood more readily by reference to the following detailed description of exemplary embodiments and the accompanying drawings. The present invention may, however, be embodied in many different forms and should not be construed as being limited to the exemplary embodiments set forth herein. Rather, these exemplary embodiments are provided so that this disclosure will be thorough and complete and will fully convey the concept of the invention to those skilled in the art, and the present invention will only be defined by the appended claims. Like reference numerals refer to like elements throughout the specification.

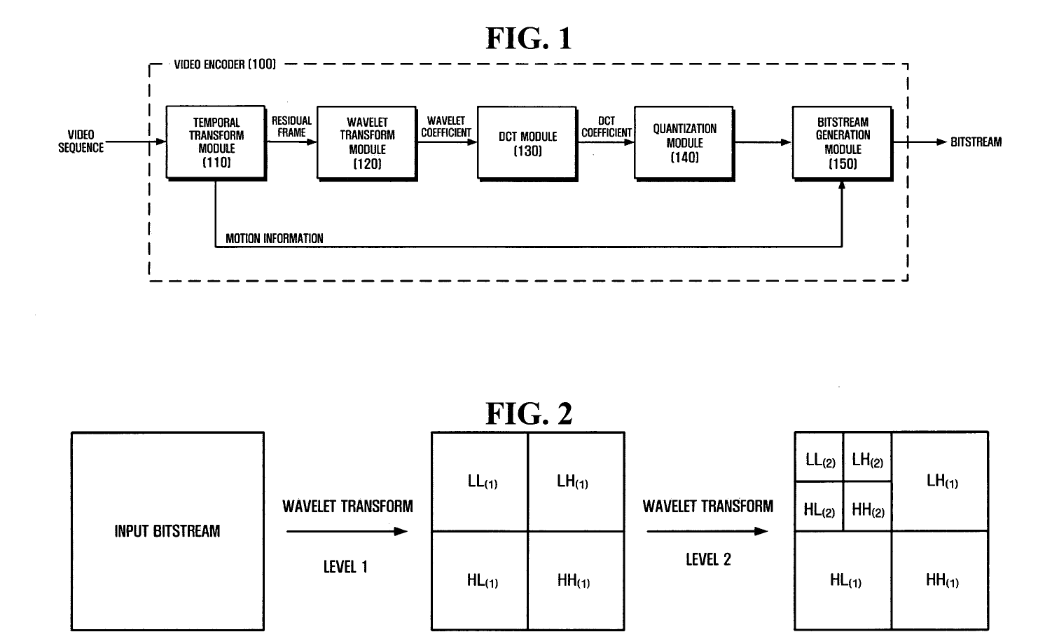

FIG. 1 shows the configuration of a video encoder 100 according to a first exemplary embodiment of the present invention.

Referring to FIG. 1, the video encoder 100 according to a first exemplary embodiment of the present invention includes a temporal transform module 110, a wavelet transform module 120, a DCT module 130, a quantization module 140, and a bitstream generation module 150. In the present exemplary embodiment, the wavelet transform is performed to remove spatial redundancies, followed by the DCT to remove additional spatial redundancies.

In order to remove temporal redundancy, the temporal transform module 110 performs motion estimation to determine motion vectors, generates a motion-compensated frame using the motion vectors and a reference frame, and subtracts the motion-compensated frame from a current fame to create a residual frame. Various algorithms such as fixed-size block matching and hierarchical variable size block matching (HVSBM) are available for motion estimation. For example, Motion Compensated Temporal Filtering (MCTF) supporting temporal scalability may be used as the temporal transform.

The wavelet transform module 120 performs wavelet transform to decompose the residual frame generated by the temporal transform module 110 into low-pass and high-passsubbands and to determine wavelet coefficients for pixels in the respective sub-bands.

FIG. 2 illustrates a process of decomposing an input image or frame into subbands at two levels by wavelet transform.

Here, “LL” represents a low-pass subband that is low frequency in both horizontal and vertical directions while “LH”, “HL” and “HH” represent high-pass subbands in horizontal, vertical, and both horizontal and vertical directions, respectively. The low-pass subband LL can be further decomposed iteratively. The numbers within the parentheses denote a level of wavelet transform.

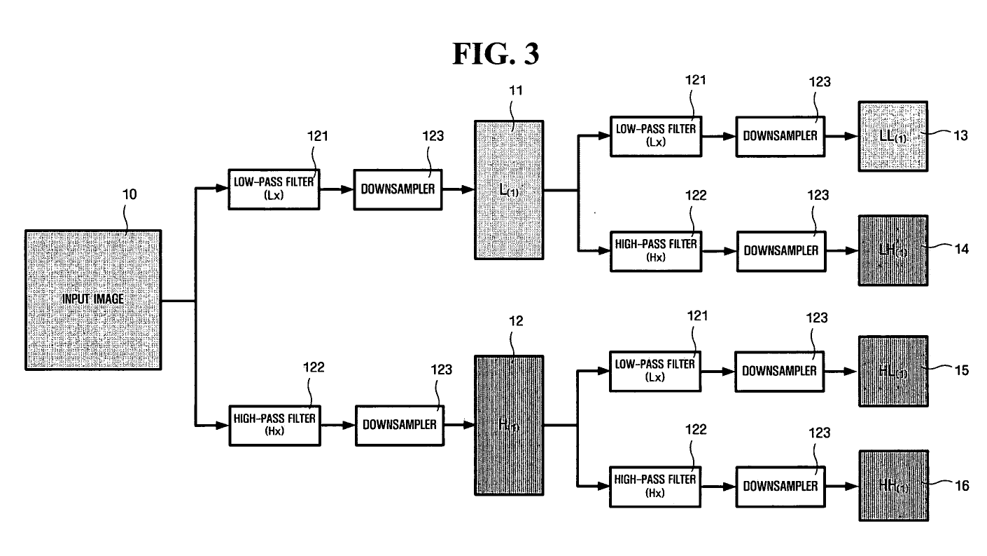

FIG. 3 is a detailed diagram illustrating the decomposing process shown in FIG. 2. The wavelet transform module 120 includes at least a low-pass filter 121, a high-pass filter 122, and a downsampler 123. Three types of wavelet filters, i.e., a Haar filter, a 5/3 filter, and a 9/7 filter, are typically used for wavelet transform. The Haar filter performs low-pass filtering and high-pass filtering using only one adjacent pixel. The 5/3 filter performs low-pass filtering using five adjacent pixels and high-pass filtering using three adjacent pixels. The 9/7 filter performs low-pass filtering based on nine adjacent pixels and high-pass filtering based on seven adjacent pixels. Video compression characteristics and video quality may vary depending on the type of a wavelet filter used.

An input image 10 is transformed into a low-pass image L₍₁₎ 11 having half the horizontal (or vertical) width of the input image 10 after it passes through the low-pass filter 121 and the downsampler 123. The input image 10 is transformed into a high-pass image H₍₁₎ 12 that is half the horizontal (or vertical) width of the input image 10 after it passes through the high-pass filter 122 and the downsampler 123.

The low-pass image L₍₁₎ 11 and the high-pass image H₍₁₎ 12 are transformed into four subband images LL₍₁₎ 13, LH₍₁₎ 14, HL₍₁₎ 15, and HH₍₁₎ 16 after they passes through the low-pass filter 121, the high-pass filter 122, and the downsampler 123.

For further decomposition (level 2), the low-pass image LL₍₁₎ 13 is decomposed in the same way into the four subband images LL₍₂₎, LH₍₂₎, HL₍₂₎, and HH₍₂₎ shown in FIG. 2.

It should be noted that in the present invention that a horizontal length and a vertical length of a low-pass image at the lowest level subband must be integer multiples of a DCT block size (“B”). If the image width and height are not integer multiples of B, compression efficiency or video quality may be significantly degraded since regions of different subbands can be included within the same DCT block. Here, “size” means the number of pixels. For a DCT block, the horizontal length is equal to the vertical length. When the horizontal length and vertical length of an input image are M and N, i.e., the input frame has M×N pixels, and the number of subband decomposition levels is k, the size of the lowest level subband is M/2^{k}×N/2^{k}. Thus, M/2^{k} and N/2^{k} must be integer multiples of B, as expressed by Equation (1):

$$\frac{M}{{2}^{k}} = mB , and \frac{N}{{2}^{k}} = nB \qquad ( 1 )$$

where m and n are integers.

For example, when the horizontal length M and the vertical length N of an input frame are 128 and 64 and a DCT block size B is 8, the maximum decomposition levels k in terms of the horizontal length M and the vertical length N are 4 and 3, respectively. Thus, the maximum decomposition levels k for the input frame is limited to 3.

As shown in Equation (1), the horizontal length M and the vertical length N are integer multiples of the DCT block size B multiplied by 2^{k}.

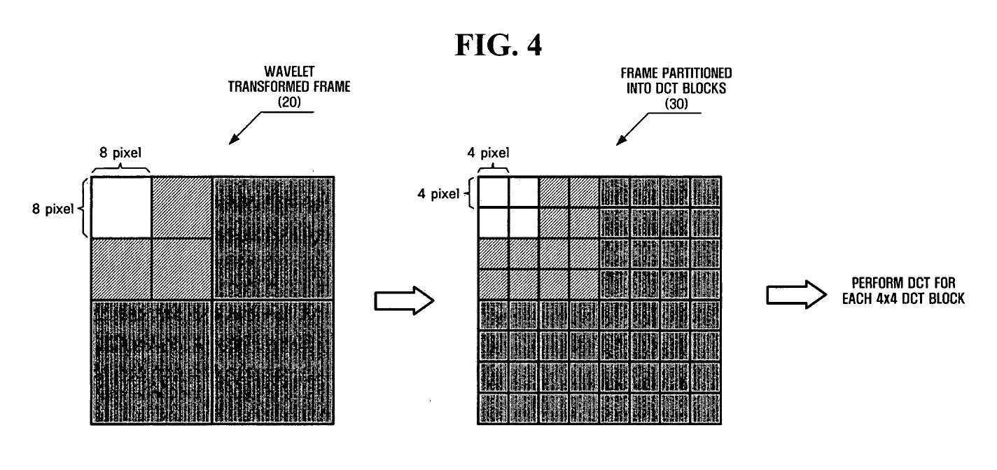

In the present invention, a frame subjected to the DCT after performing wavelet transform still retains spatial (resolution) scalability, which is a feature of wavelet transform. FIG. 4 is a diagram for explaining a process of performing the DCT on a wavelet-transformed frame 20. As illustrated in FIG. 4, a DCT block does not overlap a subband boundary. Thus, to change the resolution to that of the lowest level subband, a predecoder or transcoder may extract four DCT blocks from the upper left quadrant of a frame 30 partitioned into DCT blocks. A decoder receives the extracted data and performs an inverse DCT and an inverse wavelet transform to reconstruct a video at a reduced resolution.

The DCT module 130 (FIG. 1) partitions a wavelet-transformed frame (i.e., wavelet coefficients) into DCT blocks having a predetermined size, and performs the DCT on each DCT block to create a DCT coefficient.

Referring to FIG. 4, since the lowest subband in the two-level wavelet-transformed frame 20 has a size of 8×8 pixels, the size of a DCT block may be one of divisors of 8. Since it is assumed in the present exemplary embodiment that the DCT block size is 4, the DCT module 130 partitions the wavelet-transformed frame 20 into DCT blocks of 4×4 pixels and performs the DCT on each of the DCT blocks.

The quantization module 140 performs quantization of DCT coefficients created by the DCT module 130. Quantization is the process of converting real-valued DCT coefficients into discrete values by dividing the range of coefficients into a limited number of intervals and mapping the real-valued coefficients into quantization indices.

The bitstream generation module 150 losslessly encodes or entropy encodes the coefficients quantized by the quantization module 140 and the motion information provided by the temporal transform module 110 into an output bitstream. Various coding schemes such as Huffinan Coding, Arithmetic Coding, and Variable Length Coding may be employed for lossless coding.

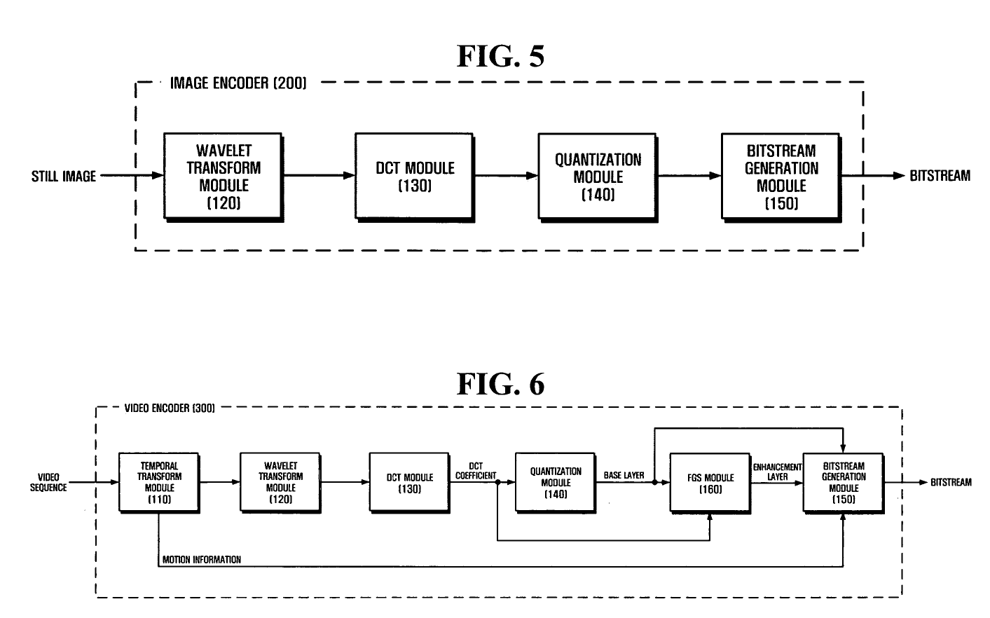

While the video encoder 100 has been described to perform encoding on an input video sequence in the exemplary embodiment shown in FIG. 1, it may also encode a still image. FIG. 5 shows the configuration of an image encoder 200 that can encode a still image. The image encoder 200 includes elements that perform the same functions as their counterparts in the video encoder 100 of FIG. 1, except for the temporal transform module 110. Instead of a residual frame obtained from a temporal residual, an original still image is input to the wavelet transform module 120.

FIG. 6 shows the configuration of a video encoder 300 for providing Fine Granular Scalability (FGS) after performing wavelet transform and DCT according to a second exemplary embodiment of the present invention.

In the present invention, spatial scalability is realized using the wavelet transform while Signal-to-Noise Ratio (SNR) scalability is implemented through FGS. To flexibly control a transmission bit-rate, part of an enhancement layer is truncated by a transcoder (or predecoder) during or after encoding. FGS is a technique to encode a video sequence into a base layer and an enhancement layer, and it is useful in performing video streaming services in an environment in which the transmission bandwidth cannot be known in advance.

In a common scenario, a video sequence is divided into a base layer and an enhancement layer. Upon receiving a request for transmission of video data at a particular bit-rate, a streaming server sends the base layer and a truncated version of the enhancement layer. The amount of truncation is chosen to match the available transmission bit-rate, thereby maximizing the quality of a decoded sequence at the given bit-rate.

Unlike the video encoder 100 shown in FIG. 1, the video encoder 300 shown in FIG. 6 further includes an FGS module 160 between a quantization module 140 and a bitstream generation module 150. The quantization module 140, the FGS module 160, and the bitstream generation module 150 will be described in the following.

DCT coefficients created after passing through a wavelet transform module 120 and a DCT module 130 are fed into the quantization module 140 and the FGS module 160. The quantization module 140 quantizes the input DCT coefficients according to predetermined criteria and creates quantization coefficients for a base layer. The criteria may be determined based on the minimum bit-rate available in a bitstream transmission environment. The quantization coefficients for the base layer are fed into the FGS module 160 and the bitstream generation module 150.

The FGS module 160 calculates the difference between each of the quantization coefficients of the base layer (received from the quantization module 140) and the corresponding DCT coefficient received from the DCT module 130, and decomposes the difference into a plurality of bit planes. A combination of the bit planes can be represented as an “enhancement layer”, which is then provided to the bitstream generation module 150.

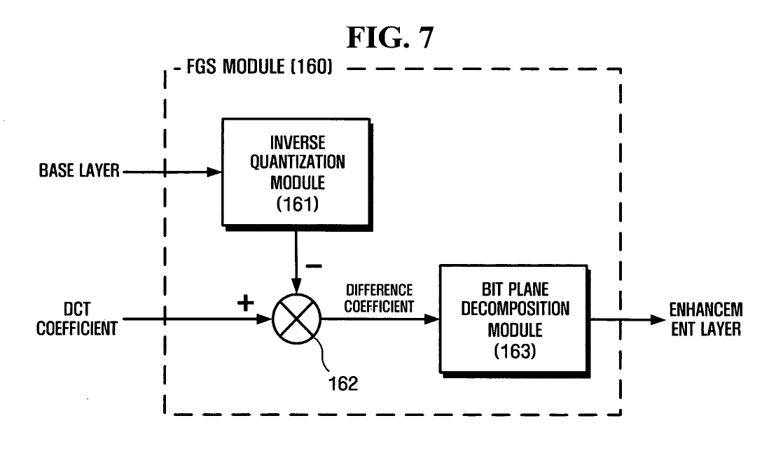

FIG. 7 shows a detailed configuration of the FGS module 160 of FIG. 6. The FGS module 160 includes an inverse quantization module 161, a differentiator 162, and a bit plane decomposition module 163. The inverse quantization module 161 dequantizes the input quantization coefficients of the base layer. The differentiator 162 calculates a difference, that is, the difference between each of the input DCT coefficients and the corresponding dequantized coefficient.

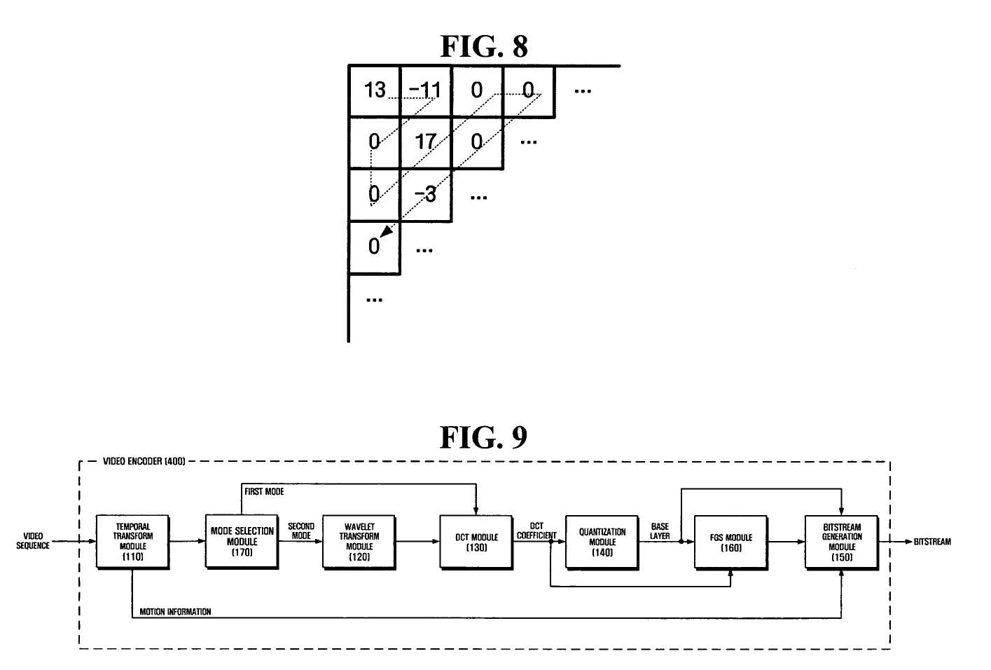

The bit plane decomposition module 163 decomposes this difference coefficient into a plurality of bit planes, and creates an enhancement layer. An example arrangement of difference coefficients is shown in FIG. 8, in which an 8×8 DCT block is shown and omitted difference coefficients are all represented by 0. The difference coefficients may be arranged in a zig-zag scan order: +13, −11, 0, 0, +17, 0, 0, 0, −3, 0, 0, . . . , and they may be decomposed into five bit planes as shown in Table 1 below.

TABLE 1
Difference Coefficients

| Value | +13 | −11 | 0 | 0 | +17 | 0 | 0 | 0 | −3 | 0 . . . |
|---|---|---|---|---|---|---|---|---|---|---|
| Bit plane 4 (2⁴) | 0 | 0 | 0 | 0 | 1 | 0 | 0 | 0 | 0 | 0 . . . |
| Bit plane 3 (2³) | 1 | 1 | 0 | 0 | 0 | 0 | 0 | 0 | 0 | 0 . . . |
| Bit plane 2 (2²) | 1 | 0 | 0 | 0 | 0 | 0 | 0 | 0 | 0 | 0 . . . |
| Bit plane 1 (2¹) | 0 | 1 | 0 | 0 | 0 | 0 | 0 | 0 | 1 | 0 . . . |
| Bit plane 0 (2⁰) | 1 | 1 | 0 | 0 | 1 | 0 | 0 | 0 | 1 | 0 . . . |

The enhancement layer represented by bit planes is arranged sequentially in a descending order (highest-order bit plane 4 to lowest-order bit plane 0) and is provided to the bitstream generation module 150. To achieve SNR scalability by adjusting the bit-rate, a transcoder or predecoder truncates the enhancement layer from the lowest-order bit plane. If all bit planes except the bit plane 4 and 3 are truncated, a decoder will receive values: +8, −8, 0, 0, 16, 0, 0, 0, 0, . . . .

The exemplary embodiment shown in FIG. 6 may also be applied to an image encoder. Unlike the video encoder 300, the image encoder does not include the temporal transform module 110, which generates motion information. Thus, an input still image is fed directly into the wavelet transform module 120.

The bitstream generation module 150 losslessly encodes or entropy encodes the quantization coefficients of the base layer which are provided by the quantization module 140, the bit planes of the enhancement layer which are provided by the FGS module 160, and the motion information provided by the temporal transform module 110 into an output bitstream.

FIG. 9 is a block diagram of a video encoder 400 according to a third exemplary embodiment of the present invention. The video encoder 400 analyzes the characteristics of a residual frame subjected to temporal transform, selects a more advantageous mode (from two modes), and performs encoding according to the selected mode. In the first mode, the video encoder 400 performs only the DCT (for spatial transform) and skips the wavelet transform. In the second mode, the video encoder 400 performs the DCT after performing the wavelet transform. Unlike the video encoder 300 of FIG. 6, the video encoder 400 further includes a mode selection module 170 between the temporal transform module 110 and the wavelet transform module 120, wherein the mode selection module 170 determines whether the residual frame will pass through the wavelet transform module 120.

In the present exemplary embodiment, the mode selection module 170 selects either the first or second mode according to the spatial correlation of the residual frame.

As described above, the DCT is suitable to transform an image having low spatial correlation and many block artifacts while the wavelet transform is suitable to transform a smooth image having high spatial correlation. Thus, criteria are needed for selecting a mode, that is, for determining whether a residual frame fed into the mode selection module 170 is an image having high spatial correlation.

For an image having high spatial correlation, pixels with a specific level of brightness are highly distributed. On the other hand, an image having low spatial correlation consists of pixels with various levels of brightness that are evenly distributed and have similar characteristics to random noise. It can be estimated that a histogram of an image consisting of random noise (the y-axis being pixel count and the x-axis being brightness) has a Gaussian distribution while that of an image having high spatial correlation does not conform to a Gaussian distribution because pixels with a specific level of brightness are highly distributed.

For example, a mode can be selected based on whether the difference between the distribution of the histogram of the input residual frame and the corresponding Gaussian distribution exceeds a predetermined threshold. If the difference exceeds the threshold, the second mode is selected because the input residual frame is determined to be highly spatially correlated. If the difference does not exceed the threshold, the residual frame has low spatial correlation, and the first mode is selected.

More specifically, a sum of differences between frequencies of each variable may be used as the difference between the current distribution and the corresponding Gaussian distribution. First, the mean m and standard deviation a of the current distribution are calculated and a Gaussian distribution with the mean m and the standard deviation a is produced. Then, as shown in Equation (2) below, the sum of differences between the frequency fᵢ of each variable in the current distribution and the frequency (f_{g})ᵢ of the variable in the Gaussian distribution are calculated and divided by the sum of frequencies in the current distribution for normalization. A mode can be selected by determining whether the resultant value exceeds a predetermined threshold c.

$$\frac{{\sum }_{i} \vert {f}_{i} - {( {f}_{g} )}_{i} \vert}{{\sum }_{i} {f}_{i}} > c \qquad ( 2 )$$

The above-mentioned criteria may be applied to a residual frame as well as an original video sequence before they are subjected to the temporal transform.

While the video encoder 400 of FIG. 9 includes an FGS module 160 that is used to support SNR scalability, the FGS module 160 may not be required. In this case, the quantization module 140 quantizes DCT coefficients created by a DCT module 130 according to the first or second mode, and the bitstream generation module 150 entropy encodes these coefficients into a bitstream.

The exemplary embodiment shown in FIG. 9 may also be applied to an image encoder. Unlike the video encoder 400, the image encoder does not include the temporal transform module 110 that generates motion information. Thus, an input still image is fed directly into the mode selection module 170.

When the first mode is selected by the mode selection module 170, a residual frame output from the temporal transform module 110 is sent directly to the DCT module 130. On the other hand, when the second mode is selected, the residual frame passes through the wavelet transform module 120, and then the DCT module 130. The same processes as shown in FIG. 6 are performed after the DCT, and thus, their description will not be given.

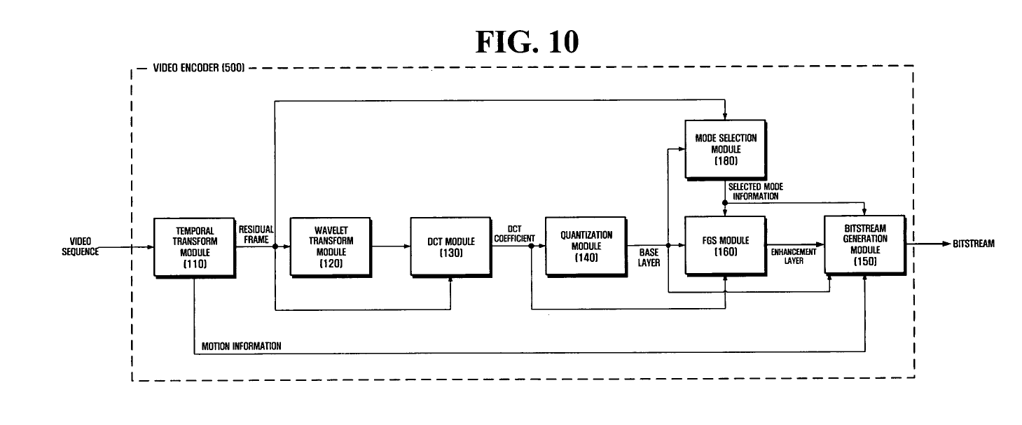

FIG. 10 is a block diagram of a video encoder 500 according to a third exemplary embodiment of the present invention. Unlike the video encoder 400 of FIG. 9, the quantization module 140 is followed by the mode selection module 150. Mode determination criteria are also different from those described with reference to FIG. 9.

A first DCT coefficient obtained after a residual frame passes through only the DCT module 130 according to the first mode, and a second DCT coefficient obtained after the residual frame passes through the wavelet transform module 120 and the DCT module 130 according to the second mode are fed into the quantization module 140.

The quantization module 140 quantizes the input first and second DCT coefficients according to a predetermined criterion to create first and second quantization coefficients of a base layer. The criterion may be determined based on the minimum bit-rate available in a bitstream transmission environment. The same criterion is applied to the first and second DCT coefficients.

The quantization coefficients for the base layer are input to the mode selection module 180. The mode selection module 180 reconstructs the first and second residual frames from the first and second quantization coefficients, compares the quality of either the first or the second residual frame with the residual frame provided by the temporal transform module 110, and selects a mode that offers a better quality residual frame.

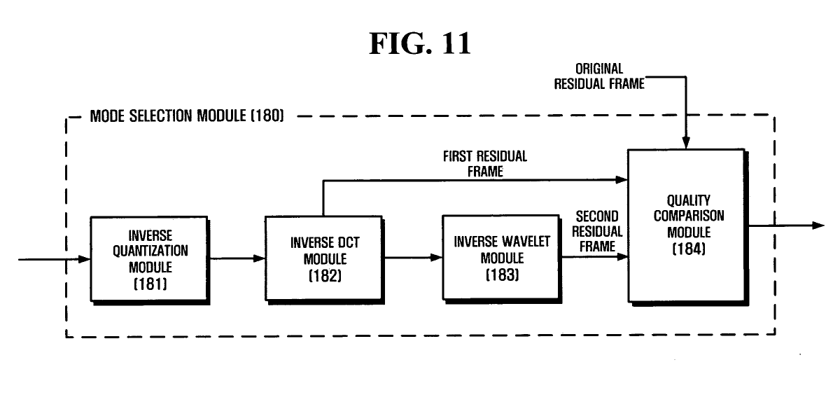

FIG. 11 shows an example of the mode selection module 180 shown in FIG. 10. Referring to FIG. 11, the mode selection module 180 includes an inverse quantization module 181, an inverse DCT module 182, an inverse wavelet transform module 183, and a quality comparison module 184.

The inverse quantization module 181 applies inverse quantization to the first and second quantization coefficients received from the quantization module 140. The inverse quantization is the process of reconstructing values from corresponding quantization indices created during a quantization process that uses a quantization table.

The inverse DCT module 182 performs inverse DCT on the inversely quantized values produced by the inverse quantization module 181, and reconstructs a first residual frame and sends it to the quality comparison module 184 in the first mode while providing the inversely DCT transformed result to the inverse wavelet transform module 183.

The inverse wavelet transform module 183 performs inverse wavelet transform on the inversely DCT transformed result received from the inverse DCT module 182, and reconstructs a second residual frame for transmission to the quality comparison module 184.

The inverse wavelet transform is a process of reconstructing an image in a spatial domain by performing the inverse wavelet transform shown in FIG. 2.

The quality comparison module 184 compares the quality of either the first or second residual frame with the original residual frame provided by the temporal transform module 110, and selects a mode that offers a better quality residual frame. To compare the video quality, the sum of differences of each of the first residual frames and the original residual frame is compared with the sum of differences of each of the second residual frames and the original residual frame, and the mode that offers a smaller sum of differences is determined to offer better video quality. The quality comparison may also be made by comparing the Peak Signal-to-Noise Ratio (PSNR) of either the first or second residual frame with that of the original residual frame. However, this method also uses the sum of differences between the PSNR of either the first or second residual frame and that of the original residual frame for video quality comparison, like in the former method using the sum of differences between residual frames.

The video quality comparison may be made by comparing images reconstructed by performing inverse temporal transform on the residual frames. However, it may be more effective to perform the comparison on the residual frames because the temporal transform is performed in both the first and second modes.

The FGS module 160 computes the difference between a DCT coefficient created according to a mode selected by the mode selection module 180 and selected quantization coefficients, and decomposes the difference into a plurality of bit planes to create an enhancement layer. When the first mode is selected, the FGS module 160 calculates the difference between a first DCT coefficient and a first quantization coefficient. When the second mode is selected, the FGS module 160 calculates the difference between a second DCT coefficient and a second quantization coefficient. The created enhancement layer is then sent to the bitstream generation module 150. Because the detailed configuration of the FGS module 160 is the same as that of its counterpart shown in FIG. 7, description thereof will not be given.

The bitstream generation module 150 receives a quantization coefficient (a first quantization coefficient for the first mode or a second coefficient for the second mode) from the quantization module 140 according to information about a mode selected by the mode selection module 180, and losslessly encodes or entropy encodes the received quantization coefficient, the bit planes provided by the FGS module 160, and the motion information provided by the temporal transform module 110 into an output bitstream.

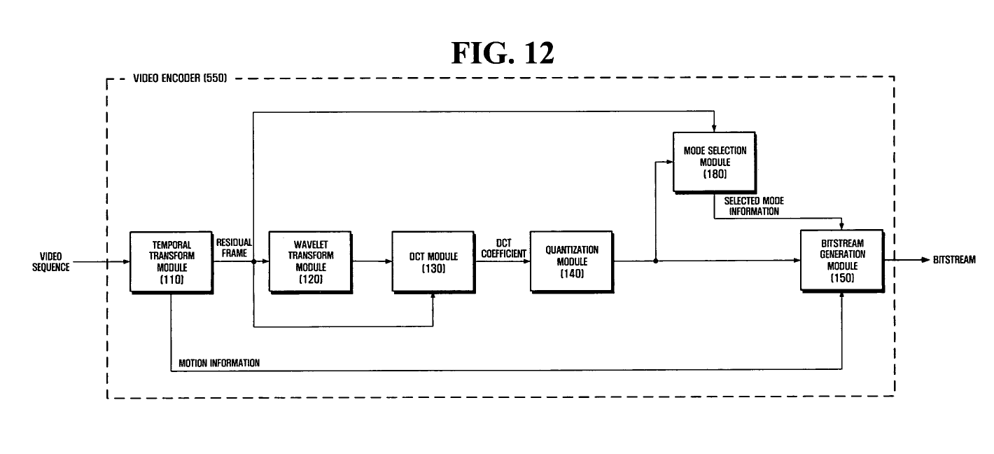

While FIG. 10 shows that the FGS module 160 is used to support SNR scalability, the FGS module 160 may be omitted (see FIG. 12). Referring to FIG. 12, when the FGS module 160 is omitted, a quantization module 140 quantizes a DCT coefficient created by the DCT module 130 according to the first or second mode, and sends the result to a mode selection module 180. The mode selection module 180 selects a mode according to the determination criteria described above and sends information about the selected mode to the bitstream generation module 150. The bitstream generation module 150 entropy-encodes the quantized result in the selected mode.

The exemplary embodiment shown in FIG. 10 may also be applied to an image encoder. Unlike the video encoder 500, the image encoder does not include the temporal transform module 110 that generates motion information. Thus, an input still image is fed directly into the wavelet transform module 120, the DCT module 130, and the mode selection module 180.

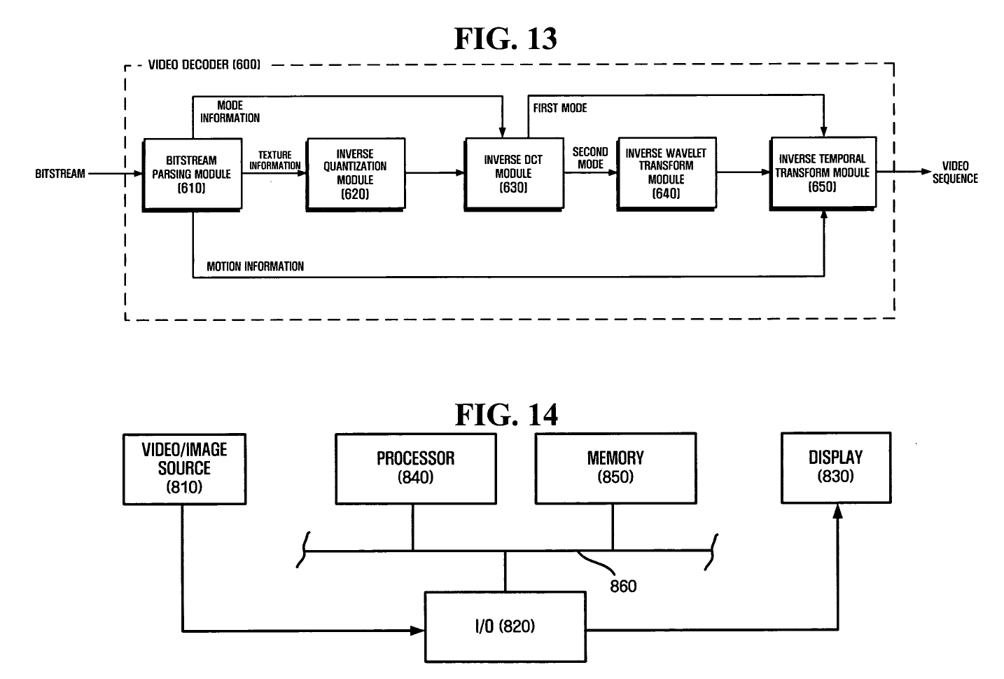

FIG. 13 is a block diagram of a video decoder 600 according to the present invention. Referring to FIG. 13, the video decoder includes a bitstream parsing module 610, an inverse quantization module 620, an inverse DCT module 630, an inverse wavelet transform module 640, and an inverse temporal transform module 650.

The bitstream parsing module 610 performs the inverse of entropy encoding by parsing an input bitstream and separately extracting motion information (motion vector, reference frame number, and others), texture information, and mode information. The inverse quantization module 620 performs inverse quantization on the texture information received from the bitstream parsing module 610. The inverse quantization is the process of reconstructing values from corresponding quantization indices created during a quantization process using a quantization table. The quantization table may be received from the encoder or it may be predetermined by the encoder and the decoder.

The inverse DCT module 630 performs inverse DCT on the inversely quantized value obtained by the inverse quantization module 620 for each DCT block, and sends the inversely DCT transformed value to the inverse temporal transform module 650 when the mode information represents the first mode, or to the inverse wavelet transform module 640 when the mode information represents the second mode.

The inverse wavelet transform module 640 performs an inverse wavelet transform on the inversely DCT transformed result received from the inverse DCT module 630. Like in the encoder, the horizontal length and the vertical length of the lowest subband image in the inverse wavelet transform must be an integer multiple of the size of the DCT block.

The inverse temporal transform module 650 reconstructs a video sequence from the inversely transformed result or the inversely wavelet transformed result according to the mode information. In this case, in order to reconstruct the video sequence, motion compensation is performed using the motion information received from the bitstream parsing module 610 to create a motion-compensated frame, and the motion-compensated frame is added to the frame received from the inverse wavelet transform module 640. While FIG. 13 shows that the inverse DCT module 630 receives the mode information, when wavelet transform and DCT are sequentially performed regardless of a mode, as shown in FIG. 1, the video sequence is reconstructed from the input bitstream that sequentially passes through the modules 610 through 650.

While the input bitstream of FIG. 13 is a video bitstream, an image decoder may be used when the input bitstream is an image bitstream. Unlike the video decoder 600 of FIG. 13, an image encoder does not include the inverse temporal transform module 650 that generates the motion information. In this case, the inverse wavelet transform module 640 outputs a reconstructed image.

FIG. 14 is a block diagram of a system for performing an encoding or decoding process according to the present invention. The system may represent a television, a set-top box, a desktop or laptop computer, a personal digital assistant (PDA), a video/image storage device such as a video cassette recorder (VCR), a digital video recorder DVR, a TiVO device, and others, as well as portions or combinations of these and other devices. The system includes one or more video/image sources 810, one or more input/output devices 820, a display 830, a processor 840, and a memory 850.

The video/image source(s) 810 may represent, e.g., a television receiver, a VCR or another video/image storage device. The source(s) 810 may alternatively represent one or more network connections for receiving video from a server or servers over, e.g., a global computer communications network such as the Internet, a wide area network, a metropolitan area network, a local area network, a terrestrial broadcast system, a cable network, a satellite network, a wireless network, or a telephone network, as well as portions or combinations of these and other types of networks.

The input/output devices 820, the processor 840 and the memory 850 may communicate over a communication medium 860. The communication medium 860 may represent, e.g., a communication bus, a communication network, one or more internal connections of a circuit, a circuit card or other device, as well as portions and combinations of these and other communication media. Input video data from the source(s) 810 is processed in accordance with one or more software programs stored in the memory 850 and executed by the processor 840 in order to generate output video/images supplied to the display device 830.

In particular, the software program stored in the memory 850 includes a scalable wavelet-based codec implementing the method of the present invention. The codec may be stored in the memory 850, read from a memory medium such as a CD-ROM or floppy disk, or downloaded from a predetermined server through a variety of networks. In other embodiments, hardware circuitry may be used in place of, or in combination with, software instructions to implement the invention.

According to the present invention, compression efficiency or video/image quality can be improved by selectively performing a spatial transform method suitable for an incoming video/image.

In addition, the present invention also provides a video/image coding method that can support spatial scalability through wavelet transform while providing SNR scalability through Fine Granular Scalability (FGS).

Although the present invention has been described in connection with the exemplary embodiments of the present invention, it will be apparent to those skilled in the art that various modifications and changes may be made thereto without departing from the scope and spirit of the invention. Therefore, it should be understood that the above exemplary embodiments are not limitative, but illustrative in all aspects.

What is claimed is:

1. A video encoder comprising:
a temporal transform module which removes a temporal redundancy in an input frame to generate a residual frame;
a wavelet transform module which performs a wavelet transform on the residual frame to generate a wavelet coefficient;
a Discrete Cosine Transform (DCT) module which performs a DCT on the wavelet coefficient for each DCT block to create a DCT coefficient; and
a quantization module for which quantizes the DCT coefficient.

2. The video encoder of claim 1, wherein a width and a height of a lowest subband image in the wavelet transform are integer multiples of a size of the DCT block.

3. The video encoder of claim 1, further comprising a bitstream generation module which losslessly encodes the quantized result.

4. The video encoder of claim 1, wherein a horizontal length and a vertical length of the input frame are an integer multiple of a size of the DCT block multiplied by 2^{k,} where k is a number of subband decomposition levels.

5. An image encoder comprising:
a wavelet transform module which performs a wavelet transform on an input image to create a wavelet coefficient;
a Discrete Cosine Transform (DCT) module which performs a DCT on the wavelet coefficient for each DCT block to create a DCT coefficient; and
a quantization module which quantizes the DCT coefficient.

6. A video encoder comprising:
a temporal transform module which removes a temporal redundancy in an input frame to generate a residual frame;
a wavelet transform module which performs a wavelet transform on the residual frame to generate a wavelet coefficient;
a Discrete Cosine Transform (DCT) module for performing a DCT on the wavelet coefficient for each DCT block to create a DCT coefficient;
a quantization module which quantizes the DCT coefficient according to a predetermined criterion and creates a quantization coefficient for a base layer; and
a Fine Granular Scalability (FGS) module which decomposes a difference between the quantization coefficient of the base layer and the DCT coefficient into a plurality of bit planes.

7. The video encoder of claim 6, wherein a horizontal length and a vertical length of a lowest subband image in the wavelet transform are integer multiples of a size of the DCT block.

8. The video encoder of claim 6, wherein the predetermined criterion is a minimum bit-rate available for a bitstream transmission environment.

9. The video encoder of claim 6, wherein the FGS module comprises:
an inverse quantization module which inversely quantizes the quantization coefficient of the base layer;
a differentiator which calculates a difference between the DCT coefficient and the inversely quantized coefficient; and
a bit plane decomposition module which decomposes the difference between the DCT coefficient and the inversely quantized coefficient into a plurality of bit planes and creates an enhancement layer.

10. A video encoder comprising:
a temporal transform module which removes a temporal redundancy in an input frame to generate a residual frame;
a mode selection module which selects one of a first mode in which only a Discrete Cosine Transform (DCT) is performed during a spatial transform and a second mode in which a wavelet transform is followed by the DCT for the spatial transform, according to a spatial correlation of the residual frame;
a wavelet transform module which performs the wavelet transform on the residual frame to generate a wavelet coefficient if the second mode is selected;
a DCT module which performs the DCT on the wavelet coefficient if the second mode is selected, and performs the DCT on the residual frame for each DCT block if the first mode is selected to thereby create a DCT coefficient; and
a quantization module for quantizing the DCT coefficient.

11. The video encoder of claim 10, wherein the spatial correlation is determined according to whether a histogram of pixels in the residual frame conforms to a Gaussian distribution.

12. A video encoder comprising:
a temporal transform module which removes temporal redundancy in an input frame to generate a residual frame;
a mode selection module which selects one of a first mode in which only a Discrete Cosine Transform (DCT) is performed during a spatial transform and a second mode in which a wavelet transform is followed by the DCT for the spatial transform, according to a spatial correlation of the residual frame;
a wavelet transform module which performs the wavelet transform on the residual frame to generate a wavelet coefficient if the second mode is selected;
a DCT module which performs the DCT on the wavelet coefficient if the second mode is selected and performs the DCT on the residual frame for each DCT block if the first mode is selected to thereby create a DCT coefficient;
a quantization module which quantizes the DCT coefficient according to a predetermined criterion and creates a quantization coefficient for a base layer; and
a Fine Granular Scalability (FGS) module which decomposes a difference between the quantization coefficient of the base layer and the DCT coefficient into a plurality of bit planes.

13. A video encoder comprising:
a temporal transform module which removes a temporal redundancy in an input frame to generate a residual frame;
a wavelet transform module which performs a wavelet transform on the residual frame to generate a wavelet coefficient;
a Discrete Cosine Transform (DCT) module which performs a DCT on the residual frame for each DCT block to generate a first DCT coefficient while performing the DCT on the wavelet coefficient for each DCT block to generate a second DCT coefficient;
a quantization module which quantizes the first and second DCT coefficients to generate first and second quantization coefficients, respectively; and
a mode selection module which reconstructs first and second residual frames from the first and second quantization coefficients, compares a quality of the first residual frame with a quality of the second residual frame, and selects a mode that offers a better quality residual frame.

14. The video encoder of claim 13, wherein the mode selection module comprises:
an inverse quantization module which inversely quantizes the first and second quantization coefficients;
an inverse DCT module which performs an inverse DCT on the inversely quantized first quantization coefficient to reconstruct the first residual frame while performing the inverse DCT on the inversely quantized second quantization coefficient;
an inverse wavelet transform module which performs an inverse wavelet transform on the inversely discrete cosine transformed second quantization coefficient to reconstruct the second residual frame; and
a quality comparison module which compares the quality of the first residual frame with the quality of the second residual frame, and selects the mode that offers the better quality residual frame.

15. The video encoder of claim 13, wherein the better quality frame is one of the first and second residual frames that offers a smaller sum of differences between either the first or second residual frame and the residual frame generated by the temporal transform module.

16. A video encoder comprising:
a temporal transform module which removes a temporal redundancy in an input frame to generate a residual frame;
a wavelet transform module which performs the wavelet transform on the residual frame to generate a wavelet coefficient;
a Discrete Cosine Transform (DCT) module which performs a DCT on the residual frame for each DCT block to generate a first DCT coefficient while performing the DCT on the wavelet coefficient for each DCT block to generate a second DCT coefficient;
a quantization module which quantizes the first and second DCT coefficients to generate first and second quantization coefficients for a base layer, respectively, according to a predetermined criterion;
a mode selection module which reconstructs first and second residual frames from the first and second quantization coefficients, compares a quality of the first residual frame with a quality of the second residual frame, and selects a mode that offers a better quality residual frame; and
a Fine Granular Scalability (FGS) module which decomposes a difference between either the first or second quantization coefficient corresponding to the selected mode and either the first or second DCT coefficient corresponding to the selected mode into bit planes.

17. An image decoder comprising:
an inverse quantization module which inversely quantizes texture information contained in an input bitstream to generate an inversely quantized value;
an inverse Discrete Cosine Transform (DCT) module which performs an inverse DCT on the inversely quantized value for each DCT block; and
an inverse wavelet transform module which performs an inverse wavelet transform on the inversely discrete cosine transformed value.

18. A video decoder comprising:
an inverse quantization module which inversely quantizes texture information contained in an input bitstream to generate an inversely quantized value;
an inverse DCT module which performs an inverse DCT on the inversely quantized value of each DCT block;
an inverse wavelet transform module which performs an inverse wavelet transform on the inversely discrete cosine transformed value; and
an inverse temporal transform module which reconstructs a video sequence using the inversely wavelet transformed value and motion information in the input bitstream.

19. A video decoder comprising:
an inverse quantization module which inversely quantizes texture information contained in an input bitstream to generate an inversely quantized value;
an inverse Discrete Cosine Transform (DCT) module which performs an inverse DCT on the inversely quantized value of each DCT block and transmits the inversely discrete cosine transformed value according to whether the mode information represents a first mode or a second mode;
an inverse wavelet transform module which receives the inversely discrete cosine transformed value if the mode information represents the second mode and performs the inverse wavelet transform on the inversely discrete cosine if the mode information represents a second mode transformed value; and
an inverse temporal transform module which receives the inversely discrete cosine transformed value from the inverse DCT module if mode information contained in the bitstream represents the first mode and reconstructs a video sequence using the inversely discrete cosine transformed value and the motion information in the bitstream if the mode information represents the first mode, and reconstructs the video sequence using the inversely wavelet transformed value and the motion information if the mode information represents the second mode.

20. A video encoding method comprising:
removing temporal redundancy in an input frame to generate a residual frame;
performing a wavelet transform on the residual frame to generate a wavelet coefficient;
performing a Discrete Cosine Transform (DCT) on the wavelet coefficient for each DCT block to create a DCT coefficient; and
quantizing the DCT coefficient,
wherein a horizontal length and a vertical length of a lowest subband image in the wavelet transform are integer multiples of a size of the DCT block.

21. The method of claim 20, wherein the horizontal length and the vertical length of the input frame are integer multiples of the size of the DCT block multiplied by 2^{k}, where k is the number of subband decomposition levels.

22. An image encoding method comprising:
performing a wavelet transform on an input image to create a wavelet coefficient;
performing a Discrete Cosine Transform (DCT) on the wavelet coefficient for each DCT block to create a DCT coefficient; and
quantizing the DCT coefficient,
wherein a horizontal length and a vertical length of a lowest subband image in the wavelet transform are integer multiples of a size of the DCT block.

23. A video encoding method comprising:
removing a temporal redundancy in an input frame to generate a residual frame;
performing a wavelet transform on the residual frame to generate a wavelet coefficient;
performing a Discrete Cosine Transform (DCT) on the wavelet coefficient for each DCT block to create a DCT coefficient;
quantizing the DCT coefficient according to a predetermined criterion and creating a quantization coefficient for a base layer; and
decomposing a difference between the quantization coefficient of the base layer and the DCT coefficient into a plurality of bit planes.

24. The video encoding method of claim 23, wherein the predetermined criterion is a minimum bit-rate available for a bitstream transmission environment.

25. A video encoding method comprising:
removing a temporal redundancy in an input frame to generate a residual frame;
selecting one of a first mode in which only a Discrete Cosine Transform (DCT) is performed during a spatial transform, and a second mode in which a wavelet transform is followed by the DCT for the spatial transform according to a spatial correlation of the residual frame;
performing the wavelet transform on the residual frame to generate a wavelet coefficient if the second mode is selected;
performing the DCT on the wavelet coefficient if the second mode is selected, as well as on the residual frame for each DCT block if the first mode is selected to thereby create a DCT coefficient; and
quantizing the DCT coefficient.

26. The video encoding method of claim 25, wherein the spatial correlation is determined according to whether a histogram of pixels in the residual frame conforms to a Gaussian distribution.

27. A video encoding method comprising:
removing temporal redundancy in an input frame to generate a residual frame;
selecting one of a first mode in which only a Discrete Cosine Transform (DCT) is performed during a spatial transform, and a second mode in which a wavelet transform is followed by the DCT for spatial transform according to a spatial correlation of the residual frame;
performing the wavelet transform on the residual frame to generate a wavelet coefficient if the second mode is selected;
performing DCT on the wavelet coefficient if the second mode is selected, and performing DCT on the residual frame for each DCT block if the first mode is selected to thereby create a DCT coefficient;
quantizing the DCT coefficient according to a predetermined criterion and creating a quantization coefficient for a base layer; and
decomposing a difference between the quantization coefficient of the base layer and the DCT coefficient into a plurality of bit planes.

28. A video encoding method comprising:
removing temporal redundancy in an input frame to generate a residual frame;
performing a wavelet transform on the residual frame to generate a wavelet coefficient;
performing a Discrete Cosine Transform (DCT) on the residual frame for each DCT block to generate a first DCT coefficient and performing the DCT on the wavelet coefficient for each DCT block to generate a second DCT coefficient;
quantizing the first and second DCT coefficients to generate first and second quantization coefficients, respectively; and
reconstructing first and second residual frames from the first and second quantization coefficients, comparing a quality of the first residual frame with a quality of the second residual frame, and selecting a mode that offers a better quality residual frame.

29. The method of claim 25, wherein the selecting of the mode comprises:
inversely quantizing the first and second quantization coefficients;
performing an inverse DCT on the inversely quantized first quantization coefficient to reconstruct the first residual frame and performing the inverse DCT on the inversely quantized second quantization coefficient;
performing an inverse wavelet transform on the inversely discrete cosine transformed second quantization coefficient to reconstruct the second residual frame; and
comparing the quality of the first residual frame with the quality of the second residual frame and selecting the mode that offers the better quality residual frame.

30. A video encoding method comprising:
removing temporal redundancy in an input frame to generate a residual frame;
performing a wavelet transform on the residual frame to generate a wavelet coefficient;
performing a Discrete Cosine Transform (DCT) on the residual frame of each DCT block to generate a first DCT coefficient, and performing the DCT on the wavelet coefficient of each DCT block to generate a second DCT coefficient;
quantizing the first and second DCT coefficients to generate first and second quantization coefficients for a base layer, respectively, according to a predetermined criterion;
reconstructing first and second residual frames from the first and second quantization coefficients, comparing a quality of the first residual frame with a quality of the second residual frame, and selecting a mode that offers a better quality residual frame; and
decomposing a difference between either the first or second quantization coefficient corresponding to the selected mode and either the first or second DCT coefficient corresponding to the selected mode into bit planes.

31. An image decoding method comprising:
inversely quantizing texture information contained in an input bitstream to generate an inversely quantized value;
performing an inverse Discrete Cosine Transform (DCT) on the inversely quantized value for each DCT block; and
performing an inverse wavelet transform on the inversely discrete cosine transformed value,
wherein a horizontal length and a vertical length of a lowest subband image in the inverse wavelet transform are integer multiples of a size of the DCT block.

32. A video decoding method comprising:
inversely quantizing texture information contained in an input bitstream to generate an inversely quantized value;
performing an inverse Discrete Cosine Transform (DCT) on the inversely quantized value of each DCT block;
performing an inverse wavelet transform on the inversely discrete cosine transformed value; and
reconstructing a video sequence using the inversely wavelet transformed value and motion information in the bitstream,
wherein a horizontal length and a vertical length of a lowest subband image in the inverse wavelet transform are integer multiples of a size of the DCT block.

33. A video decoding method comprising:
inversely quantizing texture information contained in an input bitstream to generate an inversely quantized value;
performing an inverse Discrete Cosine Transform (DCT) on the inversely quantized value of each DCT block;
reconstructing a video sequence using the inversely discrete cosine transformed value and mode information contained in the bitstream if motion information represents a first mode; and
performing an inverse wavelet transform on the inversely discrete cosine transformed value, and reconstructing a video sequence using the inversely wavelet transformed value and the motion information if the mode information represents a second mode.
